(19) United States
(12) Patent Application Publication
(10) Pub. No.: US 2015/0172868 A1
(43) Pub. Date: Jun. 18, 2015

(54) SERVER AND METHOD OF TRANSMITTING DATA THEREOF, AND MOBILE DEVICE AND SENSING METHOD THEREOF

(71) Applicant: SAMSUNG ELECTRONICS CO., LTD., Suwon-si (KR)

(72) Inventor: Sang-wook KANG, Anyang-si (KR)

(73) Assignee: SAMSUNG ELECTRONICS CO., LTD., Suwon-si (KR)

(21) Appl. No.: 14/529,648

(22) Filed: Oct. 31, 2014

(30) Foreign Application Priority Data
Dec. 13, 2013 (KR) 10-2013-0155721

(51) Int. Cl. H04W 4/02; H04L 29/08

(52) U.S. Cl. CPC H04W 4/028; H04L 67/22

(57) ABSTRACT

A server and a method of transmitting data thereof, and a mobile device and a sensing method thereof are disclosed. The sensing method includes receiving sensing data obtained according a user behavior pattern from at least one device, analyzing state information of the sensing data, and changing a user processing data according to an analysis result of state information of the sensing data.

### CROSS-REFERENCE TO RELATED APPLICATIONS

This application claims priority from Korean Patent Application No. 10-2013-0155721, filed on Dec. 13, 2013, in the Korean Intellectual Property Office, the disclosure of which is incorporated herein by reference in its entirety.

### BACKGROUND

1. Field

Apparatuses and methods consistent with one or more exemplary embodiments relate to a server and a method of transmitting data thereof, and a mobile device and a sensing method thereof, and more particularly, to a server and a method of transmitting data thereof, and a mobile device and a sensing method thereof, for determining a sensing method according to a user behavior pattern.

2. Description of the Related Art

Along with the development of a mobile device, user behavior patterns or trends have recently been determined using sensing data detected by a sensor included in a mobile device. In addition, a service provider or a content provider may actively provide services or contents appropriate for a user according to the user behavior patterns or trends determined using sensing data. Therefore, the sensing data has recently become more important.

A conventional mobile device continuously detects sensing data, such as location information, etc., of a user. In addition, the conventional mobile device transmits this detected sensing data to a server irrespective of power use and data amount.

When the sensing data is continuously detected, power consumption of the mobile device is increased. When all sensing data is transmitted to the server, redundant or unnecessary data is sent, increasing data use and also increasing a data processing amount.

### SUMMARY

Exemplary embodiments overcome the above disadvantages and other disadvantages not described above. Also, exemplary embodiments are not required to overcome the disadvantages described above, and an exemplary embodiment may not overcome any of the problems described above.

According to an aspect of one or more exemplary embodiment, a method of transmitting data includes receiving sensing data obtained according to a user behavior pattern from at least one device, analyzing state information of the sensing data, and changing a user processing data according to an analysis result of state information of the sensing data.

The receiving may include receiving the sensing data according to at least one of a place in which the at least one device is located and time of day.

The receiving may include receiving the sensing data when the at least one device is located in a first area, and not receiving the sensing data when the at least one device is located in a second area.

The receiving may include receiving the sensing data during a first time period of the day, and not receiving the sensing data during a second time period of the day.

The analyzing may include analyzing at least one among a place in which the at least one device is located and a moving state of the at least one device using the sensing data.

The user processing data may be data for indicating a point of time when sensing data of the at least one device is to be collected.

The changing may include increasing transmission frequency of the user processing data when the at least one device is moving as the analysis result of sensing data, and reducing the transmission frequency of the user processing data when the at least one device is located at a fixed place as the analysis result of sensing data.

The changing may include transmitting the user processing data to a first device when the at least one device is moving as the analysis result of sensing data, and transmitting the user processing data to a second device when the at least one device is located at a fixed place as the analysis result of sensing data.

The first device may be a wearable device by a user body and the second device may be a mobile device other than a wearable device.

According to another aspect of one or more exemplary embodiments, a server includes a communicator configured to receive sensing data obtained according to a user behavior pattern from at least one device, an analyzer configured to analyze state information of the sensing data, and a changer configured to change a user processing data according to an analysis result.

The communicator may receive the sensing data according to at least one of a place in which the at least one device is located and time of day.

The communicator may receive the sensing data when the at least one device is located in a first area, and may not receive the sensing data when the at least one device is located in a second area.

The communicator may receive the sensing data during a first time period, and may not receive the sensing data during a second time period.

The analyzer may analyze at least one of a place in which the at least one device is located and a moving state of the at least one device using the sensing data.

The user processing data may be data for determination of a point of time when sensing data of the at least one device is collected.

The changer may increase transmission frequency of the user processing data when the at least one device is moving as the analysis result of sensing data, and reduce the transmission frequency of the user processing data when the at least one device is located at a fixed place as the analysis result of sensing data.

The changer may transmit the user processing data to a first device when the at least one device is moving as the analysis result of sensing data, and transmit the user processing data to a second device when the at least one device is located at a fixed place as the analysis result of sensing data.

The first device may be a wearable device by a user body, and the second device may be a mobile device other than a wearable device.

According to another aspect of one or more exemplary embodiments, a sensing method of a mobile device includes collecting sensing data obtained according to a user behavior pattern and according to at least one of a place in which the mobile device is located and a time of day, transmitting the sensing data to a server for analyzing state information of the sensing data, and receiving user processing data corresponding to an analysis result of the state information of the sensing data is reflected, from the server.

The collecting may include collecting the sensing data when the mobile device is located in a first area, and not collecting the sensing data when the mobile device is located in a second area.

The collecting may include collecting the sensing data during a first time period, and not collecting the sensing data during a second time period.

The sensing method may further include determining a point of time when the sensing data is collected using the user processing data.

The determining may include determining to increase frequency of collection of the sensing data when transmission frequency of the user processing data is increased, and determining to reduce the frequency of collection of the sensing data when the transmission frequency of the user processing data is reduced.

The determining may include determining that a sensing device for collecting the sensing data as the mobile device and beginning to collect the sensing data when the user processing data contains information indicating that the mobile device is located at a fixed place, and determining the sensing device for collecting the sensing data as an external wearable device and stopping collecting the sensing data when the user processing data contains information indicating the mobile device is moving.

According to another aspect of one or more exemplary embodiments, a mobile device includes a sensor configured to collect sensing data obtained according to a user behavior pattern and according to at least one of a place in which the mobile device is located and a time of day, and a communicator configured to transmit the sensing data to a server for analyzing state information of the sensing data, and to receive user processing data to which analysis result of the state information of the sensing data is reflected, from the server.

The sensor may collect the sensing data obtained by detecting the user behavior pattern when the mobile device is located in a first area, and may not collect the sensing data obtained by detecting the user behavior pattern when the mobile device is located in a second area.

The sensor may collect the sensing data during a first time period, and may not collect the sensing data during a second time period.

The mobile device may further include a controller configured to determine a point of time when the sensing data is collected using the user processing data.

The controller may determine to increase frequency of collection of the sensing data when transmission frequency of the user processing data is increased, and determine to reduce the frequency of collection of the sensing data when the transmission frequency of the user processing data is reduced.

The controller may determine that a sensing device for collecting the sensing data as the mobile device and begins to collect the sensing data when the user processing data contains information indicating that the mobile device is located at a fixed place, and determine that the sensing device for collecting the sensing data as an external wearable device and stops collecting the sensing data when the user processing data contains information indicating the mobile device is moving.

According to another aspect of one or more exemplary embodiments, a sensing method of a mobile device may include collecting sensing data according to at least one among a place in which the mobile device is located and a time of day, and adjusting the collecting of sensing data according to an analysis result of state information of the sensing data.

The sensing method may further include determining to increase a frequency of collecting sensing data in response to the analysis result indicating that the mobile device is substantially stationary, and determining to decrease the frequency of collecting sensing data in response to the analysis result indicating that the mobile device is being moved.

The sensing method may further include determining to cease collecting sensing data in response to the analysis result indicating that the mobile device is in a first location, and determining to collect sensing data in response to the analysis result indicating that the mobile device is in a second location.

The sensing method may further include determining to cease collecting sensing data in response to the analysis result indicating that another mobile device is to collect sensing data, and determining to begin collecting sensing data in response to the analysis result indicating that the mobile device is to collect sensing data.

The mobile device may be a wearable device.

According to another aspect of one or more exemplary embodiments, a mobile device includes a sensor configured to collect sensing data according to at least one among a place in which the mobile device is located and a time of day, and a controller configured to control the sensor to adjust its collecting of sensing data according to an analysis result of state information of the sensing data.

The controller may be further configured to control the sensor to decrease a frequency of collecting sensing data in response to the analysis result indicating that the mobile device is substantially stationary, and to control the sensor to increase the frequency of collecting sensing data in response to the analysis result indicating that the mobile device is being moved.

The controller may be configured to control the sensor to cease collecting sensing data in response to the analysis result indicating that the mobile device is in a first location, and to control the sensor to begin collecting sensing data frequency of collecting in response to the analysis result indicating that the mobile device is in a second location.

The controller may be further configured to control the sensor to cease collecting sensing data in response to the analysis result indicating that another mobile device is to collect sensing data, and to control the sensor to collect sensing data in response to the analysis result indicating that the mobile device is to collect sensing data.

According to another aspect of one or more exemplary embodiments, a method of adjusting a collection of sensing data, includes receiving from at least one mobile device sensing data collected according to at least one of a place in which the mobile device is located and a time of day, changing a user processing data according to an analysis of the sensing data, and transmitting the changed user processing data to the at least one mobile device, wherein the changed user processing data indicates that the at least one mobile device adjust the collection of sensing data.

The changing may comprise changing the user processing data to indicate that a first mobile device among the at least one mobile device decrease a frequency of collecting sensing data in response to the analysis result indicating that the at least one mobile device is substantially stationary, and changing the user processing data to indicate that the first mobile device increase the frequency of collecting in response to the analysis result indicating that the at least one mobile device is being moved.

The changing may comprise changing the user processing data to indicate that a first mobile device among the at least one mobile device cease collecting sensing data in response to the analysis result indicating that the first mobile device is substantially stationary, and changing the user processing data to indicate that the at least one mobile device begin collecting sensing data in response to the analysis result indicating that the at least one mobile device is being moved.

According to another aspect of one or more exemplary embodiments, a server includes a communicator configured to communicate with at least one mobile device, and a controller configured to control the communicator to receive from the least one mobile device sensing data collected according to at least one of a place in which the mobile device is located and a time of day, to change a user processing data according to an analysis of the sensing data, and to control the communicator to transmit the changed user processing data to the at least one mobile device, wherein the changed user processing data indicates that the at least one mobile device adjust the collection of sensing data.

The controller may be further configured to change the user processing data to indicate that a first mobile device among the at least one mobile device decrease a frequency of collecting sensing data in response to the analysis result indicating that the at least one mobile device is substantially stationary, and to change the user processing data to indicate that the first mobile device increase the frequency of collecting in response to the analysis result indicating that the at least one mobile device is moving.

The controller may be further configured to change the user processing data to indicate that a first mobile device among the at least one mobile device cease collecting sensing data in response to the analysis result indicating that the first mobile device is substantially stationary, and to change the user processing data to indicate that the at least one mobile begin collecting sensing data in response to the analysis result indicating that the at least one mobile device is moving.

Additional and/or other aspects and advantages will be set forth in part in the description which follows and, in part, will be obvious from the description, or may be learned by practice of one or more exemplary embodiment provide.

### BRIEF DESCRIPTION OF THE DRAWING FIGURES

The above and/or other aspects of one or more exemplary embodiment will be more apparent by describing certain exemplary embodiments with reference to the accompanying drawings, in which:

FIG. 1 is a diagram illustrating a sensing control system according to an exemplary embodiment;

FIG. 2 is a block diagram illustrating the structure of a server according to an exemplary embodiment;

FIGS. 3 and 4 are diagrams illustrating a method of determining sensing frequency and subject according to a user behavior pattern according to an exemplary embodiment;

FIG. 5 is a schematic block diagram of the structure of a mobile device according to an exemplary embodiment;

FIG. 6 is a flowchart illustrating a method of transmitting data by a server according to an exemplary embodiment;

FIG. 7 is a flowchart illustrating a method of sensing a mobile device according to an exemplary embodiment;

FIG. 8 is a sequence diagram illustrating a method of transmitting data of a sensing control system according to an exemplary embodiment;

FIG. 9 is a block diagram illustrating the structure of a mobile device according to another exemplary embodiment;

FIG. 10 is a diagram illustrating a module included in a storage of a mobile device according to another exemplary embodiment;

FIGS. 11A to 13 are diagrams illustrating collecting sensing data according to a user behavior pattern according to another exemplary embodiment;

FIG. 14 is a flowchart illustrating a sensing method of a mobile device according to another exemplary embodiment; and

FIG. 15 is a sequence diagram illustrating a sensing method of a mobile device and a wearable device according to another exemplary embodiment.

### DETAILED DESCRIPTION OF EXEMPLARY EMBODIMENTS

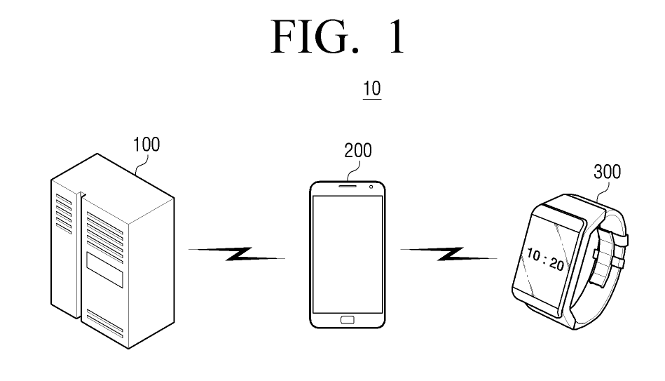

Certain exemplary embodiments will now be described in greater detail with reference to the accompanying drawings. FIG. 1 is a diagram illustrating a sensing control system 10 according to an exemplary embodiment. As illustrated in FIG. 1, the sensing control system 10 includes a server 100, a mobile device 200 and a wearable device 300. In this case, the mobile device 200 may be a smart phone as illustrated in FIG. 1, but this is purely exemplary. The mobile device 200 may be embodied as various mobile devices such as a tablet personal computer (PC), a notebook PC, etc. In addition, the wearable device 300 may be a smart watch as illustrated in FIG. 1, but this is purely exemplary. The wearable device 300 may be embodied as another wearable device, such as a smart ring, etc. Although the sensing control system 10 includes both the mobile device 200 and the wearable device 300, this is merely exemplary, and a sensing control system according to one or more exemplary embodiments may not contain both the mobile device 200 and the wearable device 300.

The mobile device 200 collects sensing data using at least one sensor. In detail, the mobile device 200 may collect various sensing data such as location information, acceleration information, illumination information, noise information, etc. using at least one sensor.

The mobile device 200 may collect sensing data according to a place that the mobile device 200 is located and a time of day. For example, when the mobile device 200 is located at a first location, the mobile device 200 may collect sensing data. When the mobile device 200 is located at a second location, the mobile device 200 may not collect sensing data. As another example, during a first time of day, the mobile device 200 may collect sensing data, and during a second time of day, the mobile device 200 may not collect sensing data. As a non-limiting example, the mobile device 200 may collect sensing data during a first period of time, such as normal awake hours, and the mobile device 200 may not collect sensing data during a second period of time, such as during normal sleeping hours.

The mobile device 200 may transmit the collected sensing data to the external server 100.

The server 100 analyzes sensing data received from at least one of the mobile device 200 and the wearable device 300. In this case, the server 100 may determine locations and moving states of the mobile device 200 and the wearable device 300 using the received sensing data. For example, when the received sensing data is sensing data containing location information, the server 100 may determine the moving states of the mobile device 200 and the wearable device 300 based on the location information of the received sensing data.

In addition, the server 100 may generate user processing data using the sensing data. In this case, the user processing data is data containing information about a user behavior pattern analyzed by sensing data, the mobile device 200 and the wearable device 300 may determine whether to sense the sensing data, based on the user processing data.

The server 100 changes a transmission state of the user processing data based on the analysis result. For example, when the analysis result of sensing data indicates that at least one of the mobile device 200 and the wearable device 300 is moving, the server 100 may increase transmission frequency of the user processing data. When the analysis result of sensing data indicates that the mobile device 200 and the wearable device 300 are located at a fixed location, the server 100 may reduce transmission frequency of the user processing data.

As another example, when the analysis result of sensing data indicates that at least one of the mobile device 200 and the wearable device 300 is moving, the server 100 may transmit the user processing data to the wearable device 300. When the analysis result of sensing data indicates that the mobile device 200 and the wearable device 300 are located at a fixed place, the server 100 may transmit the user processing data to the mobile device 200.

According to the aforementioned exemplary embodiment, the server 100 may control a sensing point of time of the sensing data to reduce power consumption of the mobile device 200 and the wearable device 300.

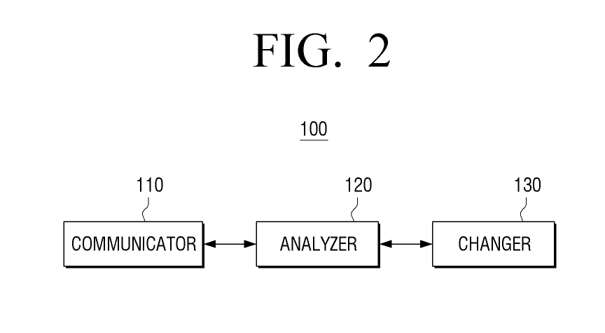

FIG. 2 is a block diagram illustrating the structure of the server 100 according to an exemplary embodiment. As illustrated in FIG. 2, the server 100 includes a communicator 110, an analyzer 120, and a changer 130.

The communicator 110 collects sensing data from at least one external device. In detail, the communicator 110 may receive sensing data obtained by detecting a user behavior pattern from at least one of the mobile device 200 and the wearable device 300.

In particular, the communicator 110 may receive the sensing data obtained by detecting the user behavior pattern according to at least one of a place and time in that at least one device is location. In detail, when at least one device is located in a first area (e.g., an office, etc.), the communicator 110 may receive the sensing data obtained by detecting the user behavior pattern. However, when the at least one device is located in a second area (e.g., a home, etc.), the communicator 110 may not receive the sensing data obtained by detecting the user behavior pattern.

In addition, the communicator 110 may receive the sensing data obtained by detecting the user behavior pattern at a first time period (e.g., from 6 am to 10 pm), and may not receive the sensing data obtained by detecting the user behavior pattern at a second time period (e.g., from 10 pm to 6 am).

The analyzer 120 analyzes state information of the sensing data received through the communicator 110. In detail, the analyzer 120 may analyze at least one of a location and moving state of at least one device using the sensing data. For example, the analyzer 120 may analyze a place where the at least one device is located using sensing data containing location information received from the at least one device and analyze a moving state of the at least one device using sensing data containing acceleration information received from the at least one device.

The analyzer 120 may generate user processing data using the analysis result of the sensing data. In this case, the user processing data is generated by analyzing sensing data received from the at least one device, for determination of a point of time for collecting sensing data of at least one device.

The user processing data may be transmitted to at least one device by the communicator 110.

The changer 130 changes a transmission state of user processing data using the analysis result. As a non-limiting example, the changer 130 may change a transmission frequency of the user processing data using the analysis result. When the analysis result of sensing data indicates that at least one device is moving, the changer 130 may increase the transmission frequency of the user processing data. When the analysis result of sensing data indicates that at least one device is located at a fixed place, the changer 130 may reduce the transmission frequency of the user processing data. For example, when the analysis result of sensing data indicates that the at least one device is moving, the changer 130 may determine transmission frequency of the user processing data as 30 times or more per second, and when the analysis result of sensing data indicates that at least one device is located at a fixed place, the changer 130 may determine the transmission frequency of the user processing data as 10 times or less per second. In this case, the changer 130 may determine transmission frequency according to a moving speed of the at least one device. That is, as a moving speed of the at least one is increased, the changer 130 may increase the transmission frequency, and as a moving speed of at least one device is reduced, the changer 130 may reduce the transmission frequency.

As another example, when the analysis result of sensing data indicates that the at least one device is moving, the changer 130 may transmit the user processing data to a first device. When the analysis result of sensing data indicates that the at least one device is located at a fixed place, the changer 130 may transmit the user processing data to a second device. For example, the first device may be a wearable device wearable on a user body and the second device may be a mobile device other than a wearable device. That is, in the case of the wearable device 300, power consumption for collection of sensing data may be smaller than the mobile device 200, and thus, the wearable device 300 may collect sensing data when the sensing frequency is increased.

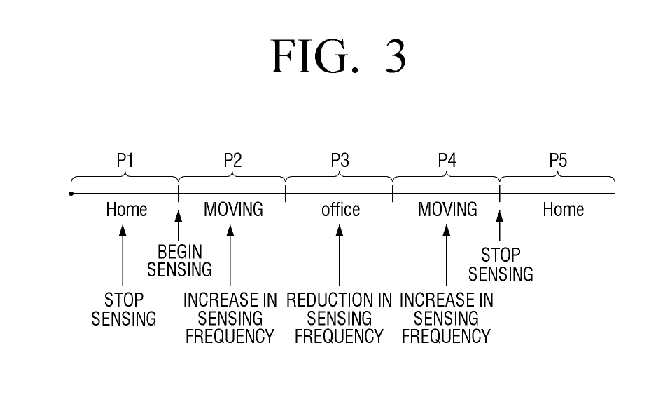

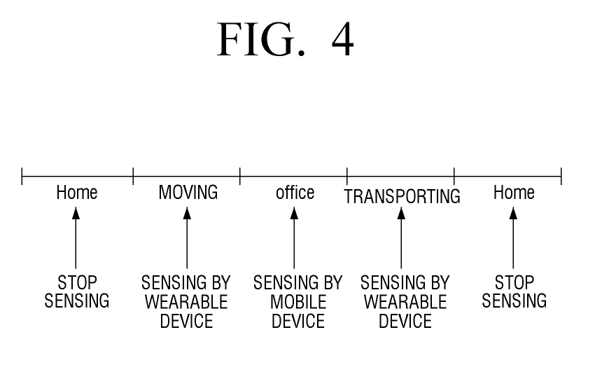

Hereinafter, a method of changing a transmission state of user processing data to determine a sensing point of time will be described with reference to FIGS. 3 and 4.

FIG. 3 is a diagram illustrating a method of controlling transmission frequency of user processing data as an analysis result of sensing data according to an exemplary embodiment.

First, when the mobile device 200 is located at home (P1), the mobile device 200 stops sensing and does not transmit sensing data to the server 100.

In addition, when the mobile device 200 leaves home, the mobile device 200 begins sensing to collect sensing data. In this case, the mobile device 200 may acquire location information through acceleration information to determine a point of time when the mobile device 200 leaves home. In addition, the mobile device 200 transmits the collected sensing data to the server 100. The server 100 analyzes the sensing data, determines that the mobile device 200 is moving (P2), and increases the sensing frequency. The mobile device 200 may increase the sensing frequency according to the transmission frequency of the user processing data.

In addition, when the mobile device 200 is located in an office (P3), the server 100 analyzes the sensing data, determines that the mobile device 200 is located at a fixed place, and reduces the transmission frequency of the user processing data. The mobile device 200 may reduce sensing frequency according to the transmission frequency of the user processing data.

In addition, when the mobile device 200 leaves an office and is moving, the server 100 analyzes the sensing data, determines that the mobile device 200 is moving (P4), and increases the sensing frequency data. The mobile device 200 may increase sensing frequency according to the transmission frequency of the user processing data.

In addition, when the mobile device 200 arrives home (P5), the mobile device 200 may stop sensing and stop transmitting the sensing data.

As described above, the transmission frequency of the user processing data may be changed according to a moving state to control sensing of the mobile device 200.

FIG. 4 is a diagram illustrating a method of controlling a transmission subject of user processing data as analysis result of sensing data according to an exemplary embodiment.

First, when the mobile device 200 and the wearable device 300 are located at home, the mobile device 200 and the wearable device 300 stop sensing and do not transmit sensing data to the server 100.

The mobile device 200 begins sensing at a point of time when the mobile device 200 leaves home and collects the sensing data. In this case, the mobile device 200 may acquire location information through acceleration information and determine a point of time when the mobile device 200 leaves home. In addition, the mobile device 200 transmits the collected sensing data to the server 100. The server 100 analyzes the sensing data to determine that the mobile device 200 is moving, and changes a transmission subject of the user processing data to the wearable device 300. The mobile device 200 stops sensing, and the wearable device 300 collects sensing data according to user processing data. In this case, the server 100 may transmit user processing data to the mobile device 200 indicating that the mobile device 200 should stop sensing.

When the mobile device 200 and the wearable device 300 are located in an office, the server 100 analyzes the sensing data received from the wearable device 300 to determine that the mobile device 200 and the wearable device 300 are located at a fixed place, and changes a transmission subject of the user processing data to the mobile device 200. The wearable device 300 stops sensing, and the mobile device 200 collects sensing data according to user processing data. In this case, the server 100 may transmit the user processing data to the wearable device 300 indicating that the wearable device 300 should stop sensing.

When the mobile device 200 and the wearable device 300 leave an office, the server 100 analyzes the sensing data received from the mobile device 200 to determine that the mobile device 200 is moving, and changes a transmission subject of the user processing data to the wearable device 300. The mobile device 200 stops sensing, and the wearable device 300 collects sensing data according to user processing data. In this case, the server 100 may transmit the user processing data to the mobile device 200 to stop sensing.

When the mobile device 200 arrives home, the mobile device 200 and the wearable device 300 may stop sensing and stop transmitting the sensing data.

As described above, a transmission subject of user processing data may be changed according to a moving state to control sensing of the mobile device 200 and the wearable device 300.

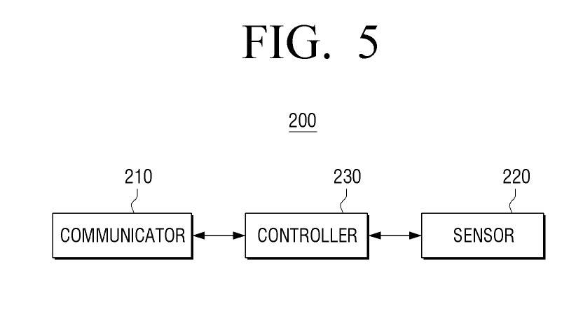

FIG. 5 is a schematic block diagram of the structure of the mobile device 200 according to an exemplary embodiment. As illustrated in FIG. 5, the mobile device 200 includes a communicator 210, a sensor 220, and a controller 230.

The communicator 210 communicates with an external device. In particular, the communicator 210 may transmit sensing data obtained by a user behavior pattern to the server 100 and receive user processing data generated by analyzing the sensing data from the server 100. In addition, the communicator 210 may communicate with the external wearable device 300.

The communicator 210 may communicate with an external device using various communication chips such as a WiFi chip, a Bluetooth chip, a near field communication (NFC) chip, a radio communication chip, etc.

The sensor 220 collects sensing data using at least one sensor. In particular, the sensor 220 may acquire location information, acceleration information, illumination information, noise information, etc. using a global positioning system (GPS) sensor, an acceleration sensor, an illumination sensor, a microphone, etc. However, the aforementioned sensor is purely exemplary and the sensor may be comprised of other sensors (e.g., a gyro sensor, etc.) in an exemplary embodiment.

The controller 230 controls an overall operation of the mobile device 200. In particular, the controller 230 may control the sensor 220 to collect sensing data according to a place that the mobile device 200 is located or a time of day, and control the communicator 210 to transmit the collected sensing data to the server 100. In detail, when the mobile device 200 is present in a first place (e.g., an office, outdoors, etc.), the controller 230 may control the sensor 220 and the communicator 210 to collect sensing data and transmit the sensing data to the server 100, and when the mobile device 200 is present in a second place (e.g., home, etc.), the controller 230 may control the sensor 220 to not collect sensing data.

In addition, the controller 230 may determine a frequency when sensing data is collected, according to the user processing data received from the server 100. That is, the controller 230 may determine the frequency and subject of collection of sensing data based on the transmission frequency and transmission subject of the user processing data. For example, when the transmission frequency of the user processing data is increased, the controller 230 may control the sensor 220 to increase collection frequency of the sensing data, and when the transmission frequency of the user processing data is reduced, the controller 230 may control the sensor 220 to reduce collection frequency of the sensing data. In addition, when the user processing data contains a command for changing a sensing device to another device, the controller 230 may control the sensor 220 to stop collecting the sensing data. In addition, when the user processing data contains a command for changing the sensing device to the mobile device 200, the controller 230 may control the sensor 220 to begin to collect the sensing data.

In addition, the controller 230 may determine a time period when sensing data is to be detected, according to the user processing data received from the server 100. For example, the controller 230 may determine a period of time (e.g., from 6 am-10 pm) when sensing data is to be detected, and a period of time (e.g., from 10 pm-6 am) when sensing data is to not be detected.

As described above, the sensing frequency and the sensing device may be determined according to a user behavior pattern, thereby reducing power consumption for the collection of sensing data of the mobile device 200.

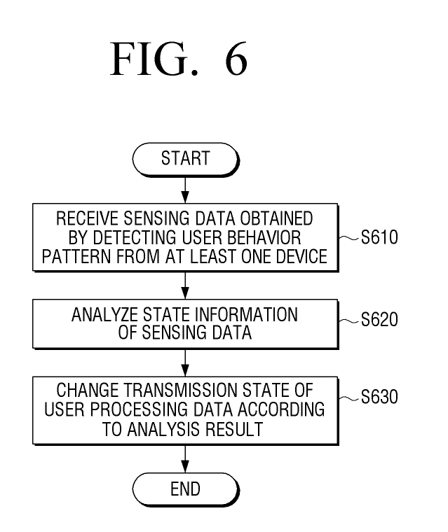

FIG. 6 is a flowchart illustrating a method of transmitting data by the server 100 according to an exemplary embodiment.

First, the server 100 receives sensing data obtained for detecting a user behavior pattern from at least one device (S610). In this case, the server 100 may receive sensing data according to a place in that at least one device is located and time of day. In detail, when at least one device is located in a first place (e.g., outdoors, office, etc.) or during a first time of day (e.g., from 6 am to 10 pm), the server 100 may receive the sensing data, and when at least one device is located in a second place (e.g., home, etc.) or during a second time of day (e.g., from 10 pm to 6 am), the server 100 may not receive the sensing data.

In addition, the server 100 analyzes state information of the sensing data (S620). In detail, the server 100 may analyze location information and moving state information of at least one device using the sensing data.

In addition, the server 100 changes a transmission state of user processing data according to an analysis result (S630). In detail, the server 100 may change the transmission frequency and transmission recipient of the user processing data according to the analysis result. For example, as the analysis result of sensing data, when it is determined that at least one device is moving, the server 100 may increase transmission frequency of the user processing data, and when it is determined the at least one device is located at a fixed place, the server 100 may reduce the transmission frequency of the user processing data. In addition, as the analysis result of sensing data, when it is determined that the at least one device is moving, the server 100 may transmit the user processing data to a first device (e.g., the wearable device 300), and as the analysis result of sensing data, when it is determined that the at least one device is located at a fixed place, the server 100 may transmit the user processing data to a second device (e.g., the mobile device 200).

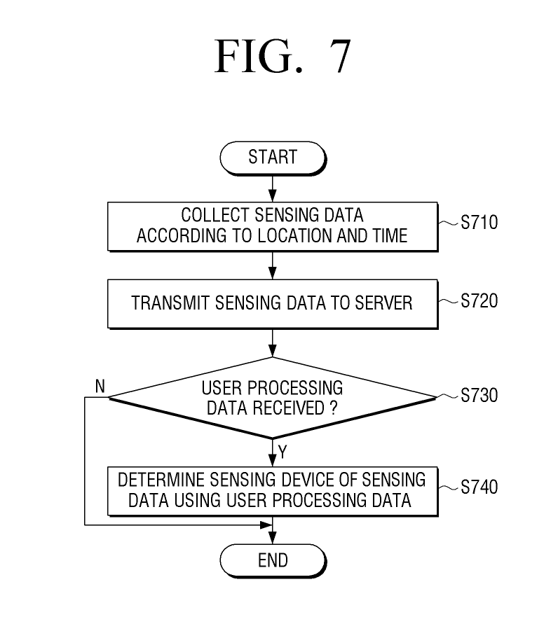

FIG. 7 is a flowchart illustrating a method of sensing the mobile device 200 according to an exemplary embodiment.

First, the mobile device 200 collects sensing data according to a location and time of day (S710).

The mobile device 200 transmits the collected sensing data to the server 100 (S720).

In addition, the mobile device 200 receives user processing data generated using sensing data (S730).

When the user processing data is received (S730-Y), the mobile device 200 determines a sensing device of the sensing data using the user processing data (S740). In detail, when the user processing data contains information for changing the sensing device of the sensing data to the wearable device 300, the mobile device 200 may stop collecting the sensing data, and when the user processing data contains information for changing the sensing device of the sensing data to the mobile device 200, the mobile device 200 may begin collecting the sensing data.

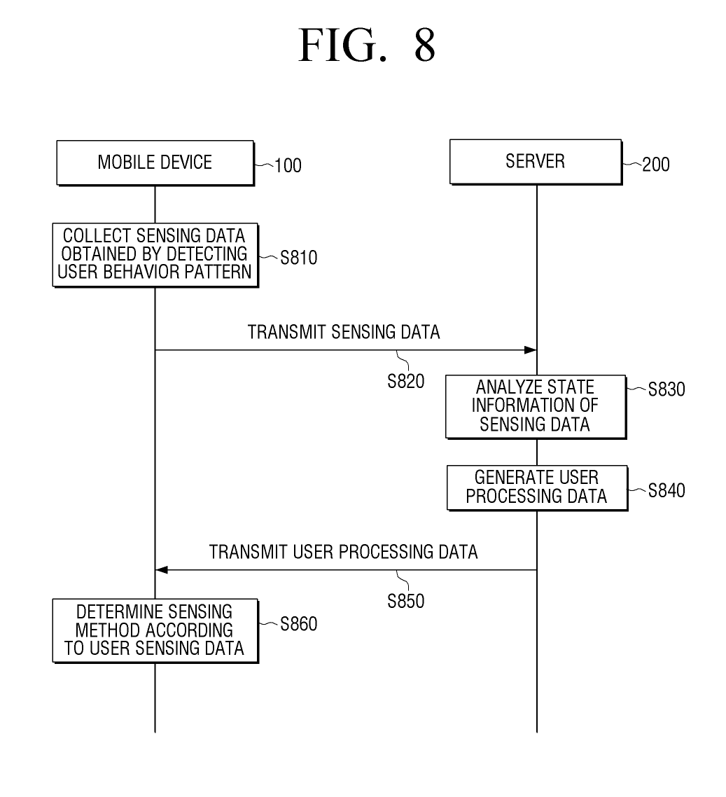

FIG. 8 is a sequence diagram illustrating a method of transmitting data of the sensing control system 10 according to an exemplary embodiment.

First, the mobile device 200 collects sensing data obtained regarding a user behavior pattern (S810). As a non-limiting example, the mobile device 200 may collect the sensing data according to a place where the mobile device 200 is located and a time of day.

The mobile device 200 transmits the sensing data to the server 100 (S820).

The server 100 analyzes state information of the sensing data (S830). In detail, the server 100 may analyze location information and moving state information of the mobile device 200 using the sensing data.

The server 100 generates user processing data (S840). In this case, the user processing data may be data for determining a point of time when the mobile device 200 is to collect the sensing data. The server 100 may change the user processing data according to the analysis result obtained by analyzing the sensing data.

The server 100 transmits the user processing data (S850).

The mobile device 200 may determine the collection of sensing data according to the user processing data (S860). For example, the mobile device 200 may determine a sensing frequency and sensing device according to the user processing data using the method illustrated in FIGS. 3 and 4.

In the aforementioned exemplary embodiment, a case in which the server 100 communicates with the mobile device 200 and the wearable device 300 has been described, but this is purely exemplary. For example, the server 100 may transmit the user processing data to the mobile device 200, and the mobile device 200 may transmit the user processing data to the wearable device 300.

In the aforementioned exemplary embodiment, a case in which the server 100 controls the mobile device 200 and the wearable device 300 has been described, but this is purely exemplary. For example, the server 100 may analyze the sensing data, and the mobile device 200 and the wearable device 300 may directly determine a sensing method using the analysis result.

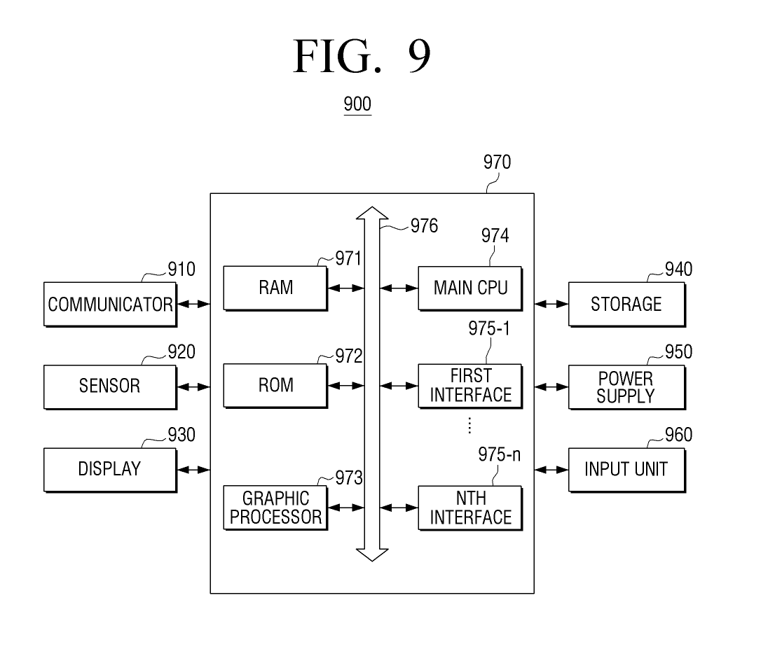

Hereinafter, a method of determining a sensing method by the mobile device 200 and the wearable device 300 will be described with reference to FIGS. 9 to 15.

A mobile device 900 collects sensing data using at least one sensor.

The mobile device 900 may determine at least one of a sensing point, sensing frequency, and a sensing device of sensing data based on a user behavior pattern. In detail, the mobile device 900 may determine a place in which the mobile device 900 is located and the user behavior pattern about a moving state of the mobile device 900. In this case, the mobile device 900 may determine the user behavior pattern using user data such as information about whether an application is executed, communication connection state, etc., and the sensing data measured by a sensor.

According to an exemplary embodiment, when the mobile device 900 stores a preferred application for each place, the mobile device 900 may determine the user behavior pattern about a place in which the mobile device 900 is located using an executed application while the mobile device 900 is located in a first device (e.g., home). In addition, when an application other than the preferred application corresponding to the first place is executed while the mobile device 900 is located in the first place, the mobile device 900 may determine the user behavior pattern such that the sensor senses location information of the mobile device 900.

As another example, the mobile device 900 may determine the user behavior pattern about a place in which the mobile device 900 is located using a communication connection state. Upon determining that the mobile device 900 is located in a first place (e.g., home) based on the communication connection state, the mobile device 900 may determine the user behavior pattern such that the sensor does not sense location information and acceleration information of the mobile device 900.

As another example, the mobile device 900 may determine the user behavior pattern about a moving state of the mobile device 900 based on user acceleration information measured by the sensor. In addition, upon determining that the mobile device 900 is fixed at a fixed place, the mobile device 900 may determine the user behavior pattern such that the sensor senses location information of the mobile device 900.

As another example, the mobile device 900 may determine the user behavior pattern about a moving state of the mobile device 900 based on the user acceleration information measured by the sensor. In addition, when it is determined that the mobile device 900 is moving, the mobile device 900 may increase sensing frequency of the sensor, and when it is determined that the mobile device 900 is located at a fixed place, the mobile device 900 may reduce the sensing frequency of the sensor.

As another example, the mobile device 900 may determine the user behavior pattern about a moving state of the mobile device 900 based on user acceleration information measured by the sensor. In addition, when the mobile device 900 communicates with the wearable device 300, if it is determined that the mobile device 900 is moving, the mobile device 900 may transmit a sensing command to the wearable device 300 and determine to stop sensing of the sensor included in the mobile device 900. When it is determined that the mobile device is located at a fixed place, the mobile device 900 may determine to begin sensing of the sensor included in the mobile device 900.

As described above, the sensing time, the sensing frequency, and the sensing device may be changed according to the user behavior pattern, thereby reducing power consumption used for collection of sensing data by the mobile device 900.

In addition, when a different behavior pattern from a previous user behavior pattern is detected, the mobile device 900 may transmit different sensing data obtained by detecting a user behavior pattern to the external server 100. For example, when a user is moving, a predetermined pattern about the user behavior pattern is searched for. When a different user pattern from the previous pattern is detected, the mobile device 900 may transmit different sensing data obtained by detecting the user behavior pattern to the external server 100. That is, when a user shows a behavior pattern of running and then walks, the mobile device 900 may transmit the sensing data obtained by detecting the user behavior pattern of walking to the external server 100.

The server 100 analyzes the sensing data obtained by detecting the user behavior pattern to generate analysis data and transmits the generated analysis data to the mobile device 900. In this case, the analysis data may be data based on the sensing data and possibility of the user behavior pattern. For example, the analysis data may be data such as data about “possibility of using application A when a user is located at home.

The mobile device 900 may store analysis data received from the server 100, and use analysis data to determine at least one of sensing point of time, sensing frequency, and a sensing device of sensing data of a next user behavior pattern.

Through the aforementioned sensing control system, the mobile device 900 may more actively reduce power consumption of the sensor.

FIG. 9 is a block diagram illustrating the structure of the mobile device 900 according to another exemplary embodiment. As illustrated in FIG. 9, the mobile device 900 includes a communicator 910, a sensor 920, a display 930, a storage 940, a power supply 950, an input unit 960, and a controller 970.

The communicator 910 communicates with various types of external devices or external servers using various types of communication methods. The communicator 910 may include various communication chips such as a WiFi chip, a Bluetooth chip, an NFC chip, a radio communication chip, etc. In this case, the WiFi chip, the Bluetooth chip, and the NFC chip may perform communication using a WiFi method, a Bluetooth method, and an NFC method. Among these, the NFC chips refers to a chip that operates using an NFC method using a band of 13.56 MHz among various RFID frequency bands such as 135 kHz, 13.56 MHz, 433 MHz, 860 to 960 MHz, 2.45 GHz, etc. When a WiFi chip or a Bluetooth chip is used, various pieces of connection information such as SSID, session key, etc. may be previously transmitted and received, and then the various pieces of information may be transmitted and received via communication connection based on the various pieces of connection information. The radio communication chip refers to a chip that performs communication according to various communication standards such as IEEE, Zigbee, 3^{rd} generation (3G), 3rd generation partnership project (3GPP), long term evolution (LTE), etc.

In particular, the communicator 910 may transmit the sensing data obtained by detecting the user behavior pattern to the server 100, and the server 100 may transmit the analysis data obtained based on the sensing data. In addition, the communicator 910 may transmit a command for changing a sensing device to the external wearable device 300 and receive the command for changing the sensing device from the wearable device 300.

The sensor 920 collects the sensing data using various sensors. For example, the sensor 920 may acquire location information using a GPS sensor, acquire acceleration information using an acceleration sensor, acquire illumination information using an illumination sensor, and acquire noise information using a microphone. However, the aforementioned sensor are purely exemplary. For example, other sensors (e.g., a gyro sensor, etc.) may also be included in an exemplary embodiment.

The display 930 may output image data according to a control of the controller 970. The display 930 may display various image data (e.g., broadcast data, etc.) received from an external source and output pre-stored graphic user interfaces (GUI).

The storage 940 stores various modules for driving the mobile device 900. For example, the storage 940 may store software such as a base module, a sensing module, a communication module, a presentation module, a web browser module, and a service module. In this case, the base module is a basic module that processes a signal transmitted from each hardware component included in the mobile device 900 and transmits the signal to a higher layer module. The sensing module may be a module that collects information from various sensors and analyzes and manages the collected information, and may include a face recognition module, a voice recognition module, a motion recognition module, an NFC recognition module, etc. The presentation module may be a module for configuring a display image and may include a multimedia module for reproducing and outputting multimedia content, and a UI rendering module for processing and configuring UIs. The communication module is a module for communication with an external device. The web browser module is a module that performs web browsing to access a web server. The service module is a module including various applications for providing various services.

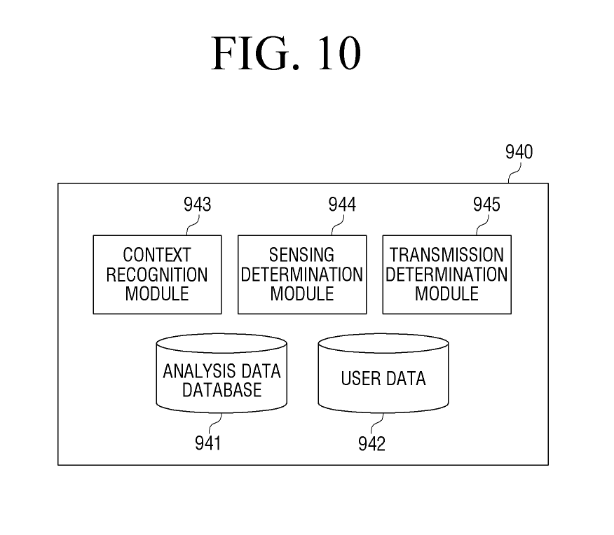

In addition, the storage 940 may include various modules for the collection of sensing data, which will be described with reference to FIG. 10. As illustrated in FIG. 10, the storage 940 includes an analysis data database 941, a user data database 942, a context recognition module 943, a sensing determination module 944, and a transmission determination module 945.

The analysis data database 941 stores analysis data received from the server 100. In this case, the analysis data may be data obtained by analyzing a correlation between the user behavior pattern and the sensing data based on probabilities. As a non-limiting example, the analysis data may be data containing information such as, “probability of execution of application A is 70% when a user is at home”. The analysis data stored in the analysis data database 941 may be updated by the analysis data transmitted from the server 100.

The user data database 942 stores user data. In this case, the user data may include application information that is frequently used by a user, communication connection information, etc.

The context recognition module 943 recognizes a current context of the mobile device 900 using the sensing data, user data, etc. For example, when it is determined that location information detected by a GPS sensor is changed, the context recognition module 943 may recognize that a location of the mobile device 900 is changed.

The sensing determination module 944 may determine a sensing point of time, sensing frequency, and sensing device based on the context recognized by the context recognition module 943. For example, when it is determined that the mobile device 900 is moving, the sensing determination module 944 may supply power to the sensor and determine to begin sensing, determine to increase sensing frequency, and determine the sensing device as the wearable device 300. In addition, when it is determined that the mobile device 900 is fixed, the sensing determination module 944 may supply power to the sensor to stop sensing, determine to reduce sensing frequency, and determine the sensing device as the mobile device 900.

The transmission determination module 945 determines whether the sensing data obtained by detecting the user behavior pattern is to be transmitted to the server 100. In this case, the transmission determination module 945 may determine whether the sensing data obtained by detecting the user behavior pattern is to be transmitted based on a location and time in that the mobile device 900 is located. For example, when the mobile device 900 is located in a first area (e.g., an office), the transmission determination module 945 may determine that the sensing data obtained by detecting the user behavior pattern is transmitted, and when the mobile device 900 is located in a second area (e.g., home), the transmission determination module 945 may determine that the sensing data obtained by detecting the user behavior pattern is not transmitted.

The plurality of modules illustrated in FIG. 10 is purely exemplary. For example, other modules for determination of collection and transmission of sensing data according to the user behavior pattern may be included.

The power supply 950 supplies power to the components of the mobile device 900. In particular, the power supply 950 may shut off or supply power to at least a portion of the sensor 920 among components of the mobile device 900 according to control of the controller 970. For example, when it is determined that the mobile device 900 is located at home, the power supply 950 may shut off power to a GPS sensor and an acceleration sensor of the sensor 920.

The input unit 960 may receive various user commands for control of the mobile device 900. In this case, the input unit 960 may be embodied as a touch panel included in the display 930.

The controller 970 controls an overall operation of the mobile device 900 using various programs stored in the storage 940.

As illustrated in FIG. 9, the controller 970 includes a random access memory (RAM) 971, a read only memory (ROM) 972, a graphic processor 973, a main central processing unit (CPU) 974, first to nth interfaces 975-1 to 975-n, and a bus 976. In this case, the RAM 971, the ROM 972, the graphic processor 973, the main CPU 974, the first to nth interfaces 975-1 to 975-n, etc. may be connected to each other via the bus 976.

The ROM 972 stores a command set, etc. for system booting. When a turn-on command is input, the main CPU 974 copies an operating system (O/S) stored in the storage 940 to the RAM 971 according to the command stored in the ROM and executes the O/S to boot the system. When booting is completed, the main CPU 974 copies various application programs stored in the storage 940 to the RAM 971, and executes the application program copied to the RAM 971 to perform various operations.

The graphic processor 973 generates an image including various objects such as an icon, an image, text, etc. using a calculator (not shown) and a renderer (not shown). The calculator calculates an attribute value such as a coordinate value, a shape, a size, color, etc. for displaying each object according to layout of the image using a control command received from the input unit 960. The renderer generates an image with various layouts, including objects, based on the attribute value calculated by the calculator. The image generated by the renderer is displayed in a display region of the display 930.

The main CPU 974 accesses the storage 940 and performs booting using the O/S stored in the storage 940. In addition, the main CPU 974 may perform various operations using various programs, content, data, etc. stored in the storage 940.

The first to nth interfaces 945-1 to 945-n are connected to the aforementioned various components. One of the interfaces may be a network interface connected to an external device through a network.

In particular, the controller 970 may determine a user behavior pattern about at least one of a location in which the mobile device 900 is located, a moving state in which the mobile device 900 is moving, and a time of day. In addition, the controller 970 may determine at least one of a sensing point of time, sensing frequency, and sensing device according to the user behavior pattern to control a sensing operation of the sensor 920.

First, the storage 940 stores information about a preferred application that is frequently used according to location as analysis data. In this case, the preferred application may refer to an application with possibility of execution of an application at the corresponding location as a predetermined value (e.g., 60%) or more.

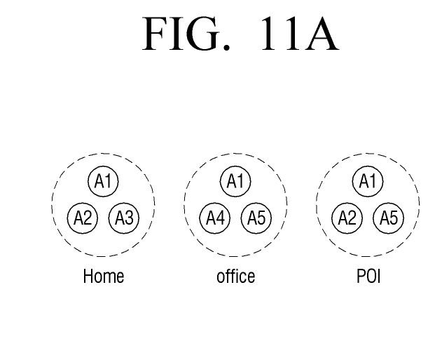

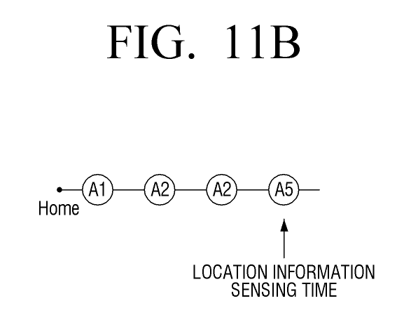

According to an exemplary embodiment, as illustrated in FIG. 11A, preferred applications at a user's home may include A1, A2, and A3, preferred applications at a user's office may include A1, A4, and A5, and preferred applications at another point of interest (POI) may include A1, A2, and A5.

The controller 970 may determine a first place in which the mobile device 900 is located using an application executed while the first place is located. For example, when applications A1, A2, and A3 are executed, the controller 970 may determine the first place in which the mobile device 900 is located is the user's home. According to the aforementioned exemplary embodiment, information about the first place in which the mobile device 900 is located is determined using user data such as application execution information. However, this is purely exemplary. For example, the information about the first place in which the mobile device 900 is located may be determined using different methods (e.g., a method using a GPS sensor of the sensor 920 and a method using a communication connection state).

When applications other than the applications corresponding to the first place are executed, the controller 970 may control the sensor 920 to sense location information of the mobile device 900. For example, as illustrated in FIG. 11B, when applications A1, A2, and A3 are executed and then an application A5 is executed, the controller 970 may sense location information using the GPS sensor at a point of time when an application A5 is executed.

The controller 970 may control the communicator 910 to transmit the sensing data including the location information at the point of time when the application A5 is executed to the server 100.

In addition, the controller 970 determines a place in which the mobile device 900 is located using a communication connection state. For example, when the communicator 910 includes a WiFi communication module, the controller 970 checks information of an access point (AP) connected to WiFi communication. In addition, ID information of the AP is “HOME”, the controller 970 may determine a place in which the mobile device 900 is currently located is the user's home.

In addition, when the place in which the mobile device 900 is located is a predetermined place, the controller 970 may control at least a portion of the sensor 920 to stop sensing. For example, when the place in which the mobile device 900 is located is determined as the user's home, the controller 970 may control the power supply 950 to stop power supply to a GPS sensor and an acceleration sensor for detection of location information and acceleration information, respectively, and stop sensing using the GPS sensor and acceleration sensor.

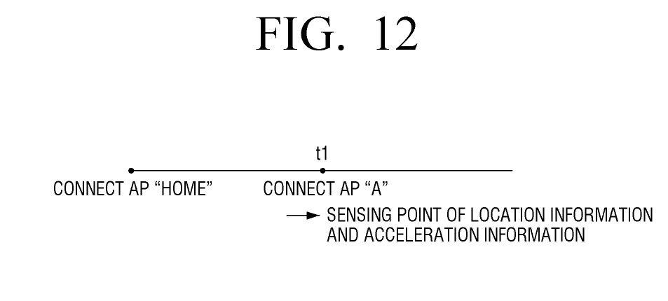

When the communication connection state is changed and the location of the mobile device 900 is changed, the controller 970 may control at least a portion of the sensor 920 to initiate sensing. For example, as illustrated in FIG. 12, when a WiFi communication module is connected to an AP with ID information of “A” at a point of time t1, the controller 970 may control the power supply 950 to supply power to a GPS sensor and an acceleration sensor and initialize sensing in order to sense location information and acceleration information.

The controller 970 may determine a moving state of the mobile device 900 based on the user acceleration information measured by the sensor 920. For example, when the acceleration sensing value is “O”, the controller 970 may determine that the mobile device 900 is located at a fixed place.

When it is determined that the mobile device 900 is located at a fixed place, the controller 970 may determine that the sensor 920 may not sense location information of the mobile device 900. That is, since the controller 970 is fixed at a fixed place, the controller 970 may control the power supply 950 to shut power to a GPS sensor so as not to redundantly and unnecessarily measure the location information that is measured once.

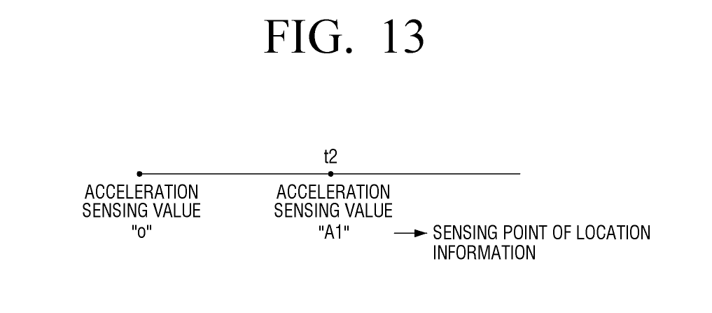

As illustrated in FIG. 13, when an acceleration sensing value is maintained as “0” and then is detected as “A1” at a point of time t2, the controller 970 may control the sensor 920 to initiate sensing location information. That is, when the acceleration sensing value is changed, the controller 970 may control the power supply 950 to supply power to the GPS sensor for detection of location information to initiate sensing the location information.

The controller 970 may control the communicator 910 to transmit sensing data including location information detected at a point of time when the acceleration value is detected as “A1” to the external server 100.

In addition, the controller 970 may determine a moving state of the mobile device 900 based on the user acceleration information measured by the sensor 920 and adjust sensing frequency of the sensor 920 according to the determined moving state. In this case, it is determined that the mobile device 900 is moving, the controller 970 may increase the sensing frequency of the sensor 920, and when it is determined that the mobile device 900 is located at a fixed place, the controller 970 may reduce the sensing frequency of the sensor 920. In this case, a sensor with adjusted sensing frequency may include various sensors such as a GPS sensor, an acceleration sensor, an illumination sensor, a noise sensor, etc.

For example, when it is determined that the mobile device 900 is fixed at home during a period of time t1 as illustrated in FIG. 3, the controller 970 may control the sensor 920 to stop sensing. In addition, when it is determined that the mobile device 900 leaves home and is moving, the controller 970 may control the sensor 920 to initiate sensing. In addition, in the case of a period of time t2 in which the mobile device 900 is moving, the controller 970 may increase the sensing frequency of the sensor 920 (e.g., from 15 to 20 times per second). In this case, the controller 970 may increase sensing frequency according to a moving speed. Like in a period of time t3, when it is determined that the mobile device 900 is located in an office, the controller 970 may reduce the sensing frequency of the sensor 920 (e.g., to 5 times per second). In the case of a period of time t4 in which the mobile device 900 is moving, the controller 970 may re-increase the sensing frequency of the sensor 920. In addition, when it is determined that the mobile device 900 returns to home, the controller 970 may control the sensor 920 to stop sensing.

As described above, the controller 970 may control the sensing frequency of the sensor 920 according to the location and moving state of the mobile device 900. In this case, at a point of time when a location is changed or a point of time when a moving state is changed, the controller 970 may control the communicator 910 to transmit the sensing data at the point of time when the location is changed or the point of time when the moving state is changed to the server 100.

In addition, the controller 970 may determine the moving state of the mobile device 900 based on the user acceleration information measured by the sensor 920. In addition, when communication of the mobile device 900 is connected to the wearable device 300, the controller 970 may determine a sensing device according to the moving state of the mobile device 900. For example, when it is determined that the mobile device 900 is moving, the controller 970 may transmit a command for changing the sensing device to the wearable device 300 and stop the sensing of the sensor 920, and when it is determined that the mobile device 900 is located at a fixed place, the controller 970 may perform a sensing operation through the sensor 920 included in the mobile device 900.

For example, as illustrated in FIG. 4, when it is determined that the mobile device 900 is located at home, the controller 970 may control the sensor 920 to stop sensing. In addition, when it is determined that the mobile device 900 leaves home, the controller 970 may determine a sensing device of the location information and the acceleration information and transmit the command for changing the sensing device to the wearable device 300. In this case, the wearable device 300 may detect the location information and the acceleration information and transmit the detected location information and acceleration information to the mobile device 900. In addition, when it is determined that the mobile device 900 is located in an office, the wearable device 300 may determine the sensing device of the location information and the acceleration information as the mobile device 900 and transmit a command for changing the sensing device to the mobile device 900. The mobile device 900 may supply power to the GPS sensor and the acceleration sensor to detect the location information and the acceleration information. In addition, when it is determined that the mobile device 900 leaves an office and is moving, the controller 970 may determine that the sensing device of the location information and the acceleration information as the wearable device 300 and transmit the command for changing the sensing device to the wearable device 300. In this case, the wearable device 300 may detect the location information and the acceleration information. When it is determined that the mobile device 900 is located at home, the wearable device 300 may stop sensing the location information and the acceleration information.

As described above, the sensing device may be changed according to the location and moving state of the mobile device 900. Thus, the wearable device 300 for easy sensing may perform a sensing operation while moving, which corresponds to high sensing frequency, and the mobile device 900 requiring much power consumption compared with the wearable device 300 may perform the sensing operation at a fixed place, which corresponds to low sensing frequency. However, this is merely exemplary, and different devices may be used for sensing under different circumstances.

The controller 970 may determine a user behavior pattern according to time information. For example, the controller 970 may determine that a user is present in a fixed place (e.g., home) from twelve at night until 7 am.

In addition, the controller 970 may determine a sensing point of time, sensing frequency, and sensing device according to the user behavior pattern based on time information. For example, the controller 970 may control the sensor 920 and the power supply 950 to stop sensing from twelve at night to 7 am and control the sensor 920 and the power supply 950 to initiate sensing from 7 am.

The controller 970 may control the communicator 910 to transmit the sensing data obtained by detecting the user behavior pattern to the server 100. In particular, when a different user behavior pattern from the previous user behavior pattern is detected, the controller 970 may control the communicator 910 to transmit the sensing data obtained by detecting the user behavior pattern to the external server 100. For example, as described above, when a different application from a preferred application is executed or at least one of the location and moving state of the mobile device 900 is changed, the controller 970 may control the communicator 910 to transmit the sensing data at the changing point of time to the server 100.

When the external server 100 transmits analysis data generated by analyzing the sensing data, the controller 970 may control the communicator 910 to receive the analysis data, stores the received analysis data in the storage 940, and update the pre-stored analysis data.

According to the aforementioned various exemplary embodiments, the mobile device 900 may reduce unnecessary power consumption for collection of sensing data. According to an exemplary embodiment, the wearable device 300 may include a similar component to the mobile device 900. However, the wearable device 300 may have lower power requirements for sensing compared with the mobile device 900, but may have low data processing speed and storage capacity compared with the mobile device 900.

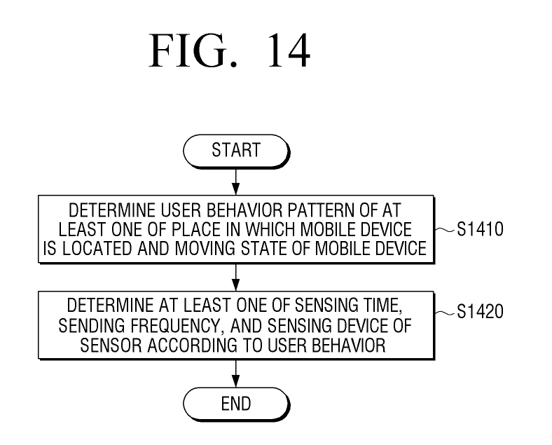

FIG. 14 is a flowchart of a sensing method of the mobile device 900 according to another exemplary embodiment.

First, the mobile device 900 determines a user behavior pattern of at least one of a location in which the mobile device 900 is located and a moving state of the mobile device 900 (S1410). In this case, the mobile device 900 may determine a place and moving state in that the mobile device 900 is located using a plurality of sensors, and at least one of an executed application and a communication connection state.

In addition, the mobile device 900 determines at least one of the sensing point of time, sensing frequency, and sensing device according to the user behavior pattern (S1420). In detail, the mobile device 900 may determine the sensing point of time of location information according to at least one of the location and moving state in that the mobile device 900 is located. For example, when the mobile device 900 is located at home, the mobile device 900 may stop sensing the location information, and when the mobile device 900 is moving, the mobile device 900 may begin to sense the location information. The mobile device 900 may determine the sensing frequency and the sensing device according to the moving state of the mobile device 900. For example, when the mobile device 900 is located at a fixed place, the mobile device 900 may reduce the sensing frequency or stop sensing. When the mobile device 900 is moving, the mobile device 900 may increase the sensing frequency or perform sensing through the external wearable device 300.

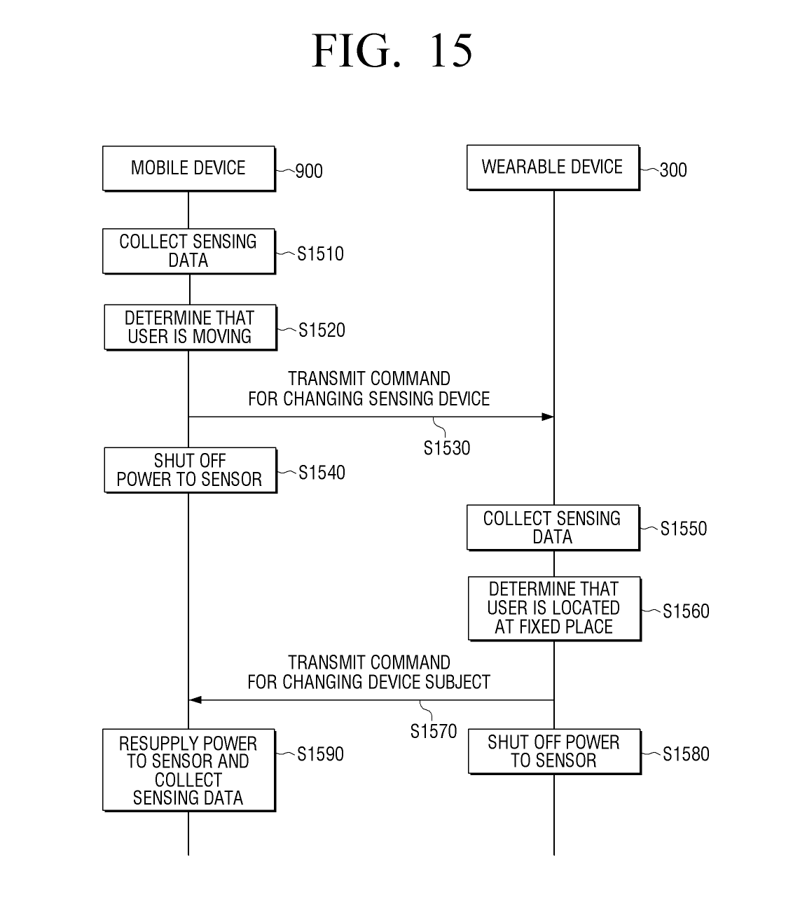

FIG. 15 is a sequence diagram illustrating a sensing method of the mobile device 900 and the wearable device 300 according to another exemplary embodiment.

First, the mobile device 900 collects sensing data using a plurality of sensors (S1510).

While collecting the sensing data, the mobile device 900 determines that a user is moving based on the sensing data (S1520).

When it is determined that the user is moving, the mobile device 900 transmits a command for changing the sensing device to the wearable device 300 (S1530). In addition, the mobile device 900 shuts off power to the sensor 920 (S1540).

The wearable device 300 supplies power to the sensor 920 and collects the sensing data (S1550).

While collecting the sensing data, the wearable device 300 determines that the user is located at a fixed place based on the sensing data (S1560).

When it is determined that the user is located at a fixed place, the wearable device 300 transmits the command for changing the sensing device to the mobile device 900 (S1570). In addition, the wearable device 300 shuts off power to the sensor 920 (S1580).

The mobile device 900 re-supplies power to the sensor 920 and collects the sensing data (S1590).

According to the aforementioned various exemplary embodiments, power consumption of a mobile device may be reduced and data processing amount of a server may also be reduced.

According to the aforementioned exemplary embodiment, the case in which the server 100 generates analysis data obtained by analyzing a correlation between sensing data and user behavior pattern has been described. However, this is purely exemplary. For example, the mobile device 900 or the wearable device 300 may generate the analysis data.

In addition, the wearable device 300 may transmit the sensing data to the mobile device 900. However, this is purely exemplary. For example, the sensing data may be transmitted directly to the server 100.

According to the aforementioned various exemplary embodiments, a sensing method of a mobile device may be embodied as a program and may be provided to the mobile device. In particular, the program containing the sensing method of the mobile device may be stored in a non-transitory computer readable medium and may be and provided.

The non-transitory computer readable medium is a medium that semi-permanently stores data and from which data is readable by a device, but not a medium that stores data for a short time, such as register, a cache, a memory, and the like. In detail, the aforementioned various applications or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

The foregoing exemplary embodiments and advantages are merely exemplary and are not to be construed as limiting the present invention. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A server comprising:
a communicator configured to receive sensing data obtained according to a user behavior pattern from at least one device;
an analyzer configured to analyze state information of the sensing data; and
a changer configured to change at least one of a user processing data and a transmission state of the user processing data according to an analysis result.

2. The server as claimed in claim 1, wherein the communicator is further configured to receive the sensing data obtained by detecting according to the user behavior pattern according to at least one of a place in which the at least one device is located and a time of day.

3. The server as claimed in claim 2, wherein the communicator is further configured to receive the sensing data when the at least one device is located in a first area, and to not receive the sensing data when the at least one device is located in a second area.

4. The server as claimed in claim 2, wherein the communicator is further configured to receive the sensing data during a first time of day, and to not receive the sensing data during a second time of day.

5. The server as claimed in claim 1, wherein the analyzer is further configured to analyze at least one of a place in which the at least one device is located and a moving state of the at least one device using the sensing data.

6. The server as claimed in claim 1, wherein the user processing data comprises data indicating a point of time when sensing data of the at least one device is to be collected.

7. The server as claimed in claim 1, wherein the changer is further configured to increase a transmission frequency of the user processing data when the at least one device is moving as the analysis result of sensing data, and to reduce the transmission frequency of the user processing data when the at least one device is located at a fixed place as the analysis result of sensing data.

8. The server as claimed in claim 1, wherein the changer is further configured to transmit the user processing data to a first device when the at least one device is moving as the analysis result of sensing data, and to transmit the user processing data to a second device when the at least one device is located at a fixed place as the analysis result of sensing data.

9. The server as claimed in claim 8, wherein:
the first device comprises a wearable device wearable by a user; and
the second device comprises a mobile device other than the wearable device.

10. A method of transmitting data, the method comprising:
receiving sensing data obtained according to a user behavior pattern from at least one device;
analyzing state information of the sensing data; and
changing at least one of a user processing data and a transmission state of the user processing data according to an analysis result of state information of the sensing data.

11. A mobile device comprising:
a sensor configured to collect sensing data obtained according to a user behavior pattern and according to at least one of a place in which the mobile device is located and a time of day; and
a communicator configured to transmit the sensing data to a server for analyzing state information of the sensing data, and to receive from the server user processing data corresponding to an analysis result of the state information of the sensing data.

12. The mobile device as claimed in claim 11, wherein the sensor is further configured to collect the sensing data when the mobile device is located in a first area, and to not collect the sensing data when the mobile device is located in a second area.

13. The mobile device as claimed in claim 11, wherein the sensor is further configured to collect the sensing data during a first time of day, and to not collect the sensing data obtained by detecting the user behavior pattern during a second time of day.

14. The mobile device as claimed in claim 11, further comprising a controller configured to determine a point of time when the sensing data is to be collected using the user processing data.

15. The mobile device as claimed in claim 14, wherein the controller is further configured to determine to increase a frequency of collection of the sensing data when a transmission frequency of the user processing data is increased, and to determine to reduce the frequency of collection of the sensing data when the transmission frequency of the user processing data is reduced.

16. The mobile device as claimed in claim 14, wherein the controller is further configured to determine that a sensing device for collecting the sensing data is to be the mobile device and begins to collect the sensing data when the user processing data contains information indicating that the mobile device is located at a fixed place, and to determine that the sensing device for collecting the sensing data is to be an external device and to stop collecting the sensing data when the user processing data contains information indicating the mobile device is moving.

17. A sensing method of a mobile device, the sensing method comprising:
collecting sensing data obtained according to a user behavior pattern and according to at least one of a place in which the mobile device is located and a time of day;
transmitting the sensing data to a server for analyzing state information of the sensing data; and
receiving from the server user processing data corresponding to an analysis result of the state information of the sensing data.

18. The sensing method as claimed in claim 17, wherein the collecting comprises collecting the sensing data when the mobile device is located in a first area, and not collecting the sensing data when the mobile device is located in a second area.

19. The sensing method as claimed in claim 17, wherein the collecting comprises collecting the sensing data during a first time of day, and not collecting the sensing data during a second time of day.

20. The sensing method as claimed in claim 17, further comprising determining a point of time when the sensing data is to be collected using the user processing data.
